(19) United States
(12) Patent Application Publication
(10) Pub. No.: US 2007/0074965 A1
(43) Pub. Date: Apr. 5, 2007

(54) ELECTRONIC DEVICE

(76) Inventors: Chih-Wei Chuang, Taipei (TW); Henry Po Hsiang Chang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/309,442

(22) Filed: Aug. 7, 2006

(30) Foreign Application Priority Data
Aug. 12, 2005 (TW) 94127444

(51) Int. Cl. H01H 3/20

(52) U.S. Cl. 200/330

(57) ABSTRACT

An electronic device including a circuit board, a substrate, and at least one button unit is provided. The circuit board has a first surface and at least one switch thereon. The substrate has a second surface, a third surface opposite to the second surface, and at least one protrusion on the second surface. The third surface of the substrate and the first surface of the circuit board are face to face, and the protrusion is above the switch. The button unit is fixed on the second surface of the substrate. The button unit has an opening, and the protrusion passes through the opening.

### CROSS-REFERENCE TO RELATED APPLICATION

This application claims the priority benefit of Taiwan application serial no. 94127444, filed on Aug. 12, 2005. All disclosure of the Taiwan application is incorporated herein by reference.

### BACKGROUND OF THE INVENTION

1. Field of Invention

The present invention relates to an electronic device. More particularly, the present invention relates to an electronic device having buttons.

2. Description of Related Art

In the age of information explosion, people can't live without electronic communication, and people have depended on electronic communication apparatuses, especially portable electronic apparatuses, in the form of mobile phones or electronic devices with wireless communication, to exchange messages. Generally, a conventional mobile phone includes a housing, a communication module disposed inside the housing, and a man machine interface (MMI) disposed on the housing and electrically connected to the communication module. The MMI is, for example, a keypad, microphone, speaker, or a display panel etc. To attract consumers' attention and motivate their purchase incentive, the appearance and style of mobile phones are constantly updated.

Although consumers always consider the price and functions when purchasing mobile phones, more and more consumers focus on the appearance of mobile phones so that the appearance of mobile phones has advanced to become curvy or stylish, unlike the old-fashioned rigid and square design. Different kinds of keypads are constantly introduced to be applied to stylish mobile phones. However, in addition to the style of the keypad, the touch feedback and the press sensitivity of the keypad are also major concerns.

The keypads in the current market can be divided into separate buttons used mostly in Japanese mobile phones and seamless buttons. The so-called separate buttons are buttons which are like independent islands from each other. The advantage of this buttons is high identification; that is, the user is less likely to press the wrong button. However, the surface area required by this kind of buttons is larger. On the other hand, NOKIA series mobile phones mostly use seamless buttons. The seamless buttons are adjacent to each other, and the advantage of this kind of buttons is that the biggest button can be designed in the smallest surface area. However, users are more likely to press the wrong button.

### SUMMARY OF THE INVENTION

Accordingly, the present invention is directed to provide an electronic device having the advantages of both the seamless buttons and separate buttons.

Based on the aforementioned and other objectives, the present invention provides an electronic device including a circuit board, a first substrate, and at least one button unit, wherein the circuit board has a first surface and at least one switch thereon. The first substrate has a second surface, a third surface opposite to the second surface, and at least one protrusion on the second surface, wherein the third surface of the substrate and the first surface of the circuit board are face to face, and the protrusion is above the switch. The button unit is fixed on the second surface of the first substrate, wherein the button unit has an opening, and the protrusion passes through the opening.

According to an embodiment of the present invention, the protrusion and the first substrate may be integrally formed.

According to an embodiment of the present invention, the diameter of the opening may be greater than the diameter of the protrusion.

According to an embodiment of the present invention, the shape of the protrusion is a cylinder.

According to an embodiment of the present invention, the button unit is affixed on the first substrate.

According to an embodiment of the present invention, the electronic device may further include a second substrate disposed between the first substrate and the circuit board. In addition, the material of the second substrate may be rubber or plastic.

According to an embodiment of the present invention, a first top surface of the protrusion and the first surface are separated with a first distance, and a second top surface of the button unit and the first surface are separated with a second distance, wherein the first distance is greater than the second distance.

According to an embodiment of the present invention, the material of the substrate may be rubber or plastic.

According to an embodiment of the present invention, the material of the button unit may be metal, rubber, or plastic.

As above described, the present invention applies the combination of a first substrate having a protrusion and a button unit having an opening, therefore the present invention not only has high identification, but also greater valid contact area. In other words, the present invention integrates the advantages of seamless buttons and separate buttons.

In order to make the aforementioned and other objects, features and advantages of the present invention comprehensible, some embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of an electronic device according to an embodiment of the present invention.

FIG. 2 is an exploded view of an electronic device according to an embodiment of the present invention.

FIG. 3 is a cross-sectional view of an electronic device according to an embodiment of the present invention.

### DESCRIPTION OF EMBODIMENTS

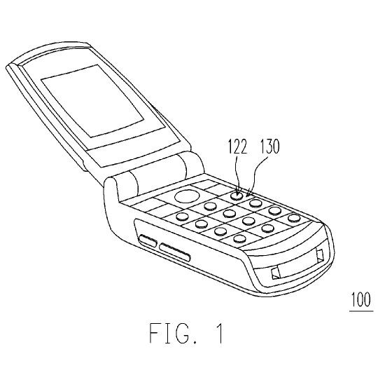

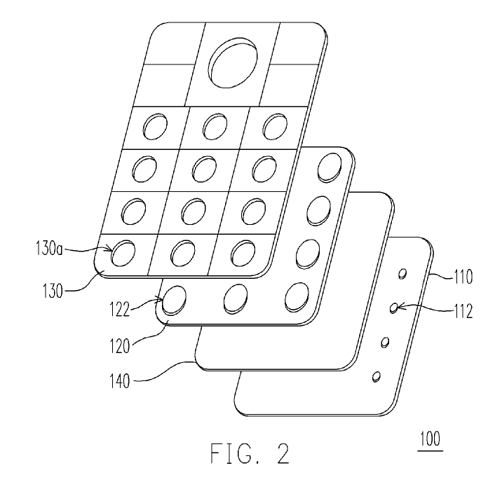

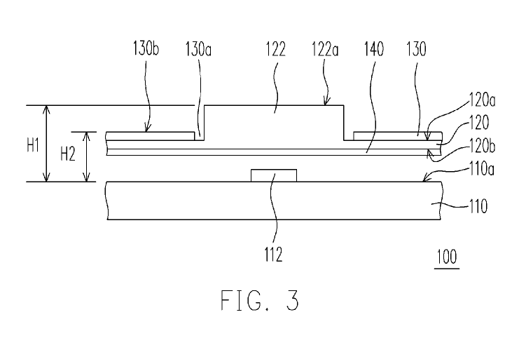

FIG. 1 is a diagram of an electronic device according to an embodiment of the present invention. FIG. 2 is an exploded view of an electronic device according to an embodiment of the present invention. FIG. 3 is a cross-sectional view of an electronic device according to an embodiment of the present invention. Referring to FIG. 1, the electronic device 100 in the present embodiment is a mobile phone. In an alternative embodiment, the electronic device 100 may be other types of mobile phone, personal digital assistant (PDA), pocket PC, notebook computer, or other electronic device having buttons.

Please refer to FIG. 2 and FIG. 3, the electronic device 100 of the present embodiment includes a circuit board 110, a first substrate 120, and at least one button unit 130, wherein the circuit board 110 has a first surface 110a and at least one switch 112 located on the first surface 110a. Moreover, the circuit board 110 may be a printed circuit board (PCB) or a flexible printed circuit (FPC), and the switch 112 may be a press switch or a thin film switch.

The first substrate 120 is located above the circuit board 110, and the first substrate 120 has a second surface 120a, a third surface 120b opposite to the second surface 120a, and at least one protrusion 122 located on the second surface 120a, wherein the third surface 120b of the first substrate 120 and the first surface 110a of the circuit board 110 are face to face, and the protrusion 122 is above the switch 112. In addition, the first substrate 120 and the protrusion 122 may be integrally formed, and the material of the first substrate 120 may be rubber or plastic. In addition, the shape of the protrusion 122 may be cylinder, regular column, or irregular column. Moreover, the height of the protrusion may be greater than 1 mm.

Each button unit 130 is fixed on the second surface 120a of the first substrate 120. For example, these button units 130 may be affixed on the first substrate 120. In addition, button units 130 are separated from one another by gaps. In other words, these button units 130s independent from each other. Furthermore, each button unit 130 has an opening 130a, and the protrusion 122 passes through the opening 130a. In the present embodiment, the diameter of the opening 130a is greater than the diameter of the protrusion 122. Moreover, the material of the button unit 130 may be metal, rubber, or plastic. To be specific, by matching the material of the button unit 130 and the material of the first substrate 120, the electronic device 100 of the present embodiment may display rich varieties of colors and texture.

Referring to FIG. 3 again, a first top surface 122a of the protrusion 122 and the first surface 110a are separated with a first distance HI, and a second top surface 130b of the button unit 130 and the first surface 110a are separated with a second distance H2, wherein the first distance H1 is greater than the second distance H2. When the user presses the protrusion 122, because the material of the first substrate 120 is elastic material, the first substrate 120 can touch the switch 112 such that the switch 112 generates a signal. Note that, because the button unit 130 is fixed on the first substrate 120, when the user presses the button unit 130 instead of the protrusion 122, the first substrate 120 can also touch the switch 112 such that the switch 112 generates a signal. In other words, regardless of the protrusion 122 or the button unit 130 pressed, the switch 112 generates a signal, thus compared with the conventional separate buttons, the present embodiment has larger valid contact area and bigger buttons. Moreover, compared with the conventional seamless buttons, because the electronic device 100 of the present embodiment has the protrusion 122 design, the electronic device 100 of the present embodiment has higher identification.

It's worth mentioning that, after the user presses the protrusion 122 or the button unit 130, for the protrusion 122 to resume its fixed position instantly, the electronic device 100 of the present embodiment may further include a second substrate 140 disposed between the first substrate 120 and the circuit board 110. Again, the material of the second substrate may be rubber or plastic.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device, comprising:
a circuit board, having a first surface and at least one switch thereon;
a first substrate, having a second surface, a third surface opposite to the second surface, and at least one protrusion on the second surface, wherein the third surface of the first substrate and the first surface of the circuit board are face to face, and the protrusion is above the switch; and
at least one button unit fixed on the second surface of the first substrate, the button unit having an opening, and the protrusion passing through the opening.

2. The electronic device as claimed in claim 1, wherein the protrusion and the first substrate are integrally formed.

3. The electronic device as claimed in claim 1, wherein the diameter of the opening is greater than the diameter of the protrusion.

4. The electronic device as claimed in claim 1, wherein the shape of the protrusion is a cylinder.

5. The electronic device as claimed in claim 1, wherein the button unit is affixed to the first substrate.

6. The electronic device as claimed in claim 1, further comprising a second substrate disposed between the first substrate and the circuit board.

7. The electronic device as claimed in claim 6, wherein the material of the second substrate is rubber or plastic.

8. The electronic device as claimed in claim 1, wherein a first top surface of the protrusion and the first surface are separated with a first distance, and a second top surface of the button unit and the first surface are separated with a second distance, and the first distance is greater than the second distance.

9. The electronic device as claimed in claim 1, wherein the material of the first substrate is rubber or plastic.

10. The electronic device as claimed in claim 1, wherein the material of the button unit is metal, rubber, or plastic.
